(19) United States
(12) Patent Application Publication
(10) Pub. No.: US 2005/0108440 A1
(43) Pub. Date: May 19, 2005

(54) Method and system for coalescing input output accesses to a virtual device

(75) Inventors: Daniel P. Baumberger, Cornelius, OR (US); Christopher Lord, Portland, OR (US)

Correspondence Address: LAWRENCE CHO;C/O PORTFOLIOIP, P. O. BOX 52050, MINNEAPOLIS, MN, 55402, US

(73) Assignee: Intel Corporation

(21) Appl. No.: 10/716,753

(22) Filed: Nov. 19, 2003

(51) Int. Cl. G06F 3/00

(52) U.S. Cl. 710/1

(57) ABSTRACT

A method for performing virtualization includes executing a plurality of input output (IO) instructions from an instruction stream during a single virtualization event.

### FIELD

An embodiment of the present invention relates to virtualization. More specifically, an embodiment of the present invention relates to a method and apparatus for coalescing input and output (IO) accesses to a virtual device.

### BACKGROUND

Recently industry trends, such as server consolidation and the proliferation of inexpensive shared-memory multiprocessors, have fueled a resurgence of interest in server virtualization techniques. Virtual machines are particularly attractive for server virtualization. Each virtual machine is given the illusion of executing on a dedicated physical machine that is fully protected and isolated from other virtual machines. Virtual machines can also be convenient abstractions of server workloads, because they can cleanly encapsulate the entire state of a running system, including both user-level applications and kernel mode operating system services. In many computing environments, individual servers are underutilized, allowing them to be consolidated as virtual machines on a single physical server with little or no performance penalty. Similarly, many small servers can be consolidated onto fewer larger machines to simplify management and reduce costs.

When an application on a virtual machine requires access to an input output device via repeated access to one or more control registers, the virtualization event causes inefficiencies which require emulation of each access before resuming execution of the application. The virtualization events are extremely expensive compared to other operations, costing more than twice that of hardware interrupts.

One known technique used to address the issues associated with a virtualization event involves creating special device drivers for commonly used devices. These special device drivers would be written to minimize the number of exits from a virtual machine and the number of general protection faults generated by the system. Although this technique was effective in some instances, these special device drivers were not always available for all devices or all operating systems that may wish to access the devices.

Thus, what is needed is an effective and efficient method and apparatus for managing input output accesses to a virtual device.

### BRIEF DESCRIPTION OF THE DRAWINGS

The features and advantages of the present invention are illustrated by way of example and are by no means intended to limit the scope of the present invention to the particular embodiments shown, and in which:

FIG. 1 is a block diagram that illustrates components of a system in which an embodiment of the invention resides;

FIG. 2 illustrates an embodiment of the physical machine in the system according to an embodiment of the present invention;

FIG. 3 is a block diagram that illustrates sub-components residing in the components of the system according to an embodiment of the invention;

FIG. 4 illustrates components of a virtual machine monitor according to an embodiment of the present invention;

FIG. 5 is a flow chart of a method for performing input output accesses on a virtual device according to an embodiment of the present invention;

FIG. 6 is a flow chart of a method for performing input output accesses on a virtual device according to a second embodiment of the present invention;

FIG. 7 is a flow chart of a method for performing input output accesses on a virtual device according to a third embodiment of the present invention; and

FIG. 8 is an exemplary instruction stream that is processed may by a virtual machine monitor according to an embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

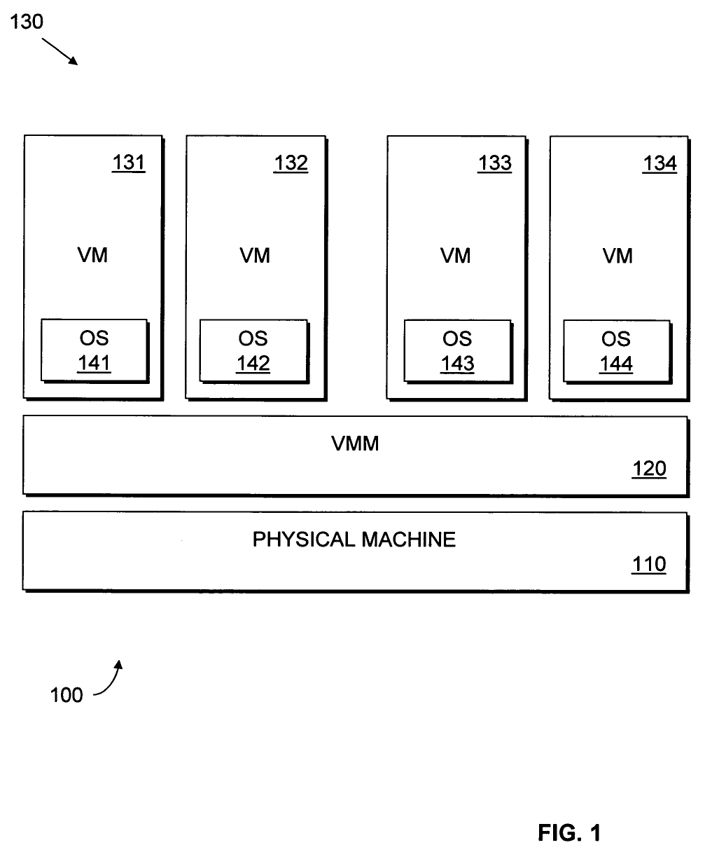

FIG. 1 is a block diagram that illustrates components of a system 100 in which an embodiment of the invention resides. The system includes a physical machine 110. According to one embodiment, the physical machine 110 may be components of a computer system (not shown). The computer system may include, for example, a processor, a memory, buses, and various input output (IO) devices (not shown).

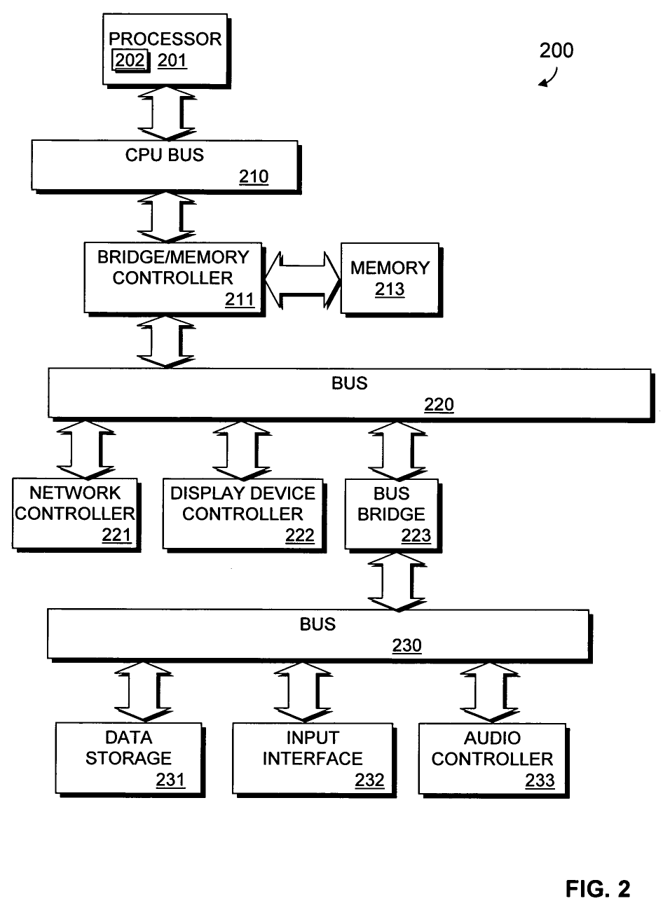

FIG. 2 is a block diagram of an exemplary computer system 200 according to an embodiment of the present invention. The computer system 200 may be used to implement the physical machine 110 shown in FIG. 1. The computer system 200 includes a processor 201 that processes data signals. The processor 201 may be a complex instruction set computer microprocessor, a reduced instruction set computing microprocessor, a very long instruction word microprocessor, a processor implementing a combination of instruction sets, or other processor device. FIG. 2 shows the computer system 200 with a single processor. However, it is understood that the computer system 200 may operate with multiple processors. The processor 201 is coupled to a CPU bus 210 that transmits data signals between processor 201 and other components in the computer system 200.

The computer system 200 includes a memory 213. The memory 213 may be a dynamic random access memory device, a static random access memory device, or other memory device. The memory 213 may store instructions and code represented by data signals that may be executed by the processor 201. A cache memory 202 resides inside processor 201 that stores data signals stored in memory 213. The cache 202 speeds up memory accesses by the processor 201 by taking advantage of its locality of access. In an alternate embodiment of the computer system 200, the cache 202 resides external to the processor 201. A bridge memory controller 211 is coupled to the CPU bus 210 and the memory 213. The bridge memory controller 211 directs data signals between the processor 201, the memory 213, and other components in the computer system 200 and bridges the data signals between the CPU bus 210, the memory 213, and a first IO bus 220.

The first IO bus 220 may be a single bus or a combination of multiple buses. The first IO bus 220 provides communication links between components in the computer system 200. A network controller 221 is coupled to the first IO bus 220. The network controller 221 may link the computer system 200 to a network of computers (not shown) and supports communication among the machines. A display device controller 222 is coupled to the first IO bus 220. The display device controller 222 allows coupling of a display device (not shown) to the computer system 200 and acts as an interface between the display device and the computer system 100.

A second IO bus 230 may be a single bus or a combination of multiple buses. The second IO bus 230 provides communication links between components in the computer system 200. A data storage device 231 is coupled to the second IO bus 230. The data storage device 231 may be a hard disk drive, a floppy disk drive, a CD-ROM device, a flash memory device or other mass storage device. An input interface 232 is coupled to the second IO bus 230. The input interface 232 may be, for example, a keyboard and/or mouse controller or other input interface. The input interface 232 may be a dedicated device or can reside in another device such as a bus controller or other controller. The input interface 232 allows coupling of an input device to the computer system 200 and transmits data signals from an input device to the computer system 200. An audio controller 233 is coupled to the second IO bus 230. The audio controller 233 operates to coordinate the recording and playing of sounds and is also coupled to the IO bus 230. A bus bridge 223 couples the first IO bus 220 to the second IO bus 230. The bus bridge 223 operates to buffer and bridge data signals between the first IO bus 220 and the second IO bus 230.

Referring back to FIG. 1, the system 100 includes a virtual machine monitor (VMM) 120. The VMM 120 is a layer that interfaces the physical machine 110 and that facilitates a plurality of virtual machines (VMs) 130 to be run. The virtual machine monitor 120 manages and mediates computer system resources in the physical machine 110 between the virtual machines and allows the isolation of or data sharing between virtual machines. The virtual machine monitor 120 achieves this by virtualizing resources in the physical machine 110 and exporting a virtual hardware interface that could reflect an underlying architecture of the physical machine 110, a variant of the physical machine, or an entirely different physical machine.

The system 100 also includes one or more virtual machines 131-134 (collectively shown as 130). According to an embodiment of the present invention, a virtual machine may be described as an isolated virtual replica of a machine including, but not limited to, a replica of the physical machine, a subset of the physical machine, or replica of an entirely different machine. The virtual machine may include the resources of the computer system in the physical machine 110, a subset of the resources of the computer system in the physical machine 110, or entirely virtual resources not found in the physical machine.

According to an embodiment of the present invention, the virtual machine monitor 120 takes complete control of the physical machine 110 and creates virtual machines 130, each of which behaves like a complete physical machine that can run its own operating system (OS). Virtual machines 131-134 may run operating systems 141-144 respectively where the operating systems 141-144 may be unique to one another. To maximize performance, the virtual machine monitor 120 allows a virtual machine to execute directly on the resources of the computer system in the physical machine 110 when possible. The virtual machine monitor 120 takes control, however, whenever a virtual machine attempts to perform an operation that may affect the operation of other virtual machines or of the operation of resources in the physical machine 110. The virtual machine monitor 120 emulates the operation and returns control to the virtual machine when the operation is completed.

In virtualizing IO devices, the virtual machine manager 120 intercepts IO operations issued by an operating system on a virtual machine. The IO operations may be, for example, IN and OUT instructions or memory mapped IO instructions. The IO instructions directing IO operations are trapped by the virtual machine manager 120 and are emulated by the virtual machine manager 120. IO instructions typically include addresses that are not valid outside the virtual machine. Emulation of these instructions becomes necessary because the instructions cannot be executed natively on the resources of the physical machine 110. An IO operation is considered a virtualization event (VM exit) since it requires its corresponding IO instruction to be emulated by the virtual machine manager 120. A virtualization event requires storing the state of the processor for a current virtual machine and reloading this state when the virtualization event is complete. This may require several thousand processor clock cycles which is costly. According to an embodiment of the present invention, the virtual machine manager 120 coalesces a plurality of IO instructions in an instruction stream and emulates them during a single virtualization event in order to reduce the overall cost of executing an instruction stream.

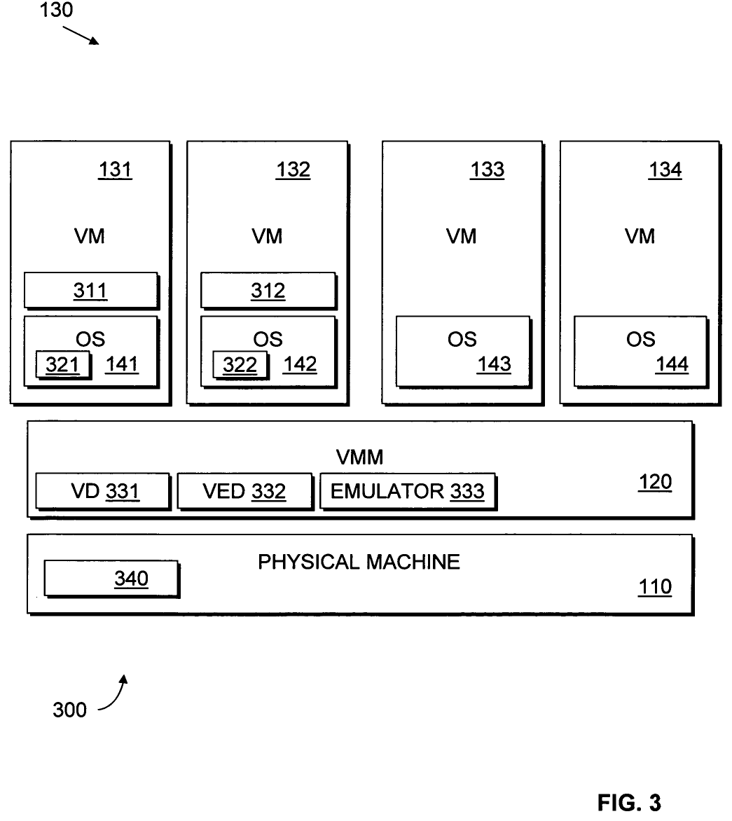

FIG. 3 is a block diagram that illustrates the sub-components residing in the components of the system according to an embodiment of the invention. The system 300 includes components similar to the components in the system 100 illustrated in FIG. 1. A first application 311 running in an application space of a first virtual machine 131 may include instructions in its instruction stream to access physical device 340 in the physical machine 110. A second application 312 running in an application space of a second virtual machine 132 may include instructions in its instruction stream to access physical device 340 in the physical machine 110. A device driver 321 running in a kernel space of a first operating system 141 of the first virtual machine 131 communicates with a virtual device 331 in the virtual machine monitor 120 via a virtualization event dispatcher (VED) 332. A device driver 322 running in a kernel space of a second operating system 142 of the second virtual machine 132 communicates with the virtual device 331 in the virtual machine monitor via the virtualization event dispatcher 332. The virtual device 331 virtualizes the functionalities of the physical device 340. The virtual device 330 also facilitates correct emulation of the physical device 340 to the device drivers 321 and 322 utilizing emulator 333 and coordinates access to the physical device 340 when necessary.

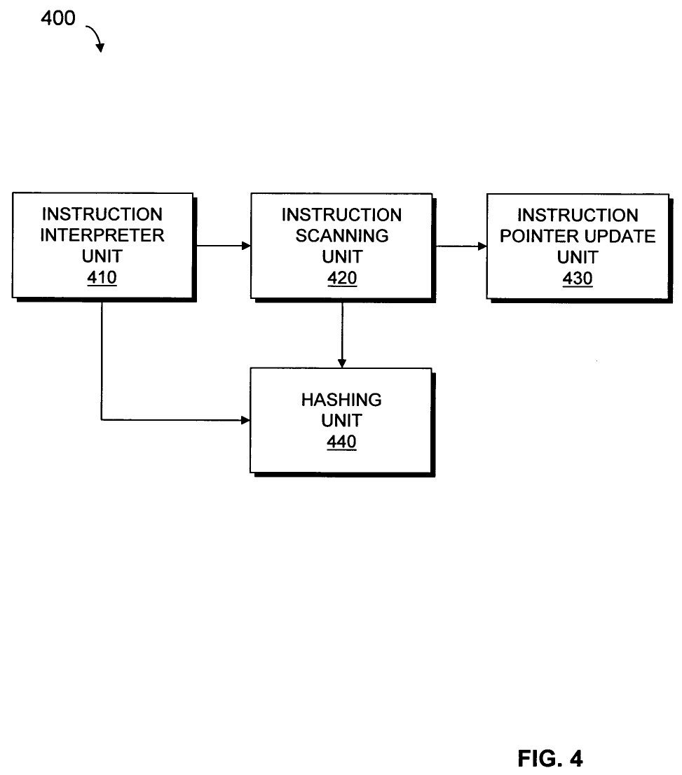

FIG. 4 illustrates a virtualization event dispatcher 400 according to an embodiment of the present invention. The virtualization event dispatcher 400 may be used to implement the virtualization event dispatcher 332 shown in FIG. 3. The virtualization event dispatcher 400 includes an instruction interpreter unit 410. The instruction interpreter unit 410 receives instructions from device drivers in virtual machines. The instruction interpreter unit 410 determines whether an instruction received that causes a virtualization event is an IO instruction directing an IO operation. According to an embodiment of the present invention, the instruction interpreter unit 410 makes this determination by identifying whether the instruction received is an IN and OUT instruction or a memory mapped IO instruction.

The virtualization event dispatcher 400 includes an instruction scanning unit 420. In response to the instruction interpreter unit 410 determining that an instruction received is an IO instruction, the instruction scanning unit 420 accesses the instruction stream originating the received IO instruction. According to an embodiment of the virtualization event dispatcher 400, the instruction scanning unit 420 interfaces with the virtual machine running the instruction stream in order to access the instruction stream. The instruction scanning unit 420 scans the instruction stream to determine whether additional IO instructions are present within an extent of instructions in the instruction stream.

In one embodiment, the extent of instructions used for determining whether additional IO instructions are present is determined based on the type of hardware components in the physical machine 110 (shown in FIG. 1). The type of hardware components may include, for example, the type of processor in the physical machine 110. In this example, the more powerful the processor, the greater number of lines may be designated for the extent. The extent of instructions used for determining whether additional IO instructions are present may also be determined by the type of software on the virtual machine and/or other criteria.

If the instruction scanning unit 420 determines that additional IO instructions are present within the extent of instructions, the additional IO instructions along with any intermediate non-IO instructions in the instruction stream are grouped together and identified with the original received IO instruction as a block of instructions. The block of instructions is directed to be emulated in the virtual machine monitor during the virtualization event.

The virtualization event dispatcher 400 includes an instruction pointer update unit 430. The instruction pointer update unit 430 interfaces with the instruction pointers in the virtual machines of a system. When instructions in an instruction stream have been emulated by a virtual machine monitor, the instruction pointer update unit 430 updates the instruction pointer of the virtual machine running the instruction stream to move past the instructions that were emulated. Upon completion of the virtualization event, the instruction pointer of the virtual machine is directed to accurately point to the appropriate instruction that should be executed when control is returned to the virtual machine.

The virtualization event dispatcher 400 includes a hashing unit 440. According to an embodiment of the present invention, the hashing unit 440 performs a hash function on a block of instructions identified by the instruction scanning unit 420 and the address of the originally received IO instruction. According to one embodiment, the hashing unit 440 stores the computed hash value with the received IO address and a value indicating the size of the block of instructions in a table (not shown). The table may reside in a virtual device corresponding to a physical device with which the IO instruction is directed to. In this embodiment, the hashing unit 440 searches for addresses of IO instructions identified by the instruction interpreter unit 410 in the table. If a matching address is found, a block of instructions from the instruction stream is identified using the information corresponding to the matching address in the table. The hashing unit 440 performs a hash function on the block of instructions and the address of the IO instruction identified by the instruction interpreter unit 410. If the computed hash value matches the hash value corresponding to the matching address on the table, the block of instructions is emulated.

According to an alternate embodiment of the present invention, the hashing unit 440 performs a hash function on the block of instructions identified by the instruction scanning unit 420. The hashing unit 440 stores the hashed value of the block of instruction into a table. According to an embodiment of the virtualization event dispatcher 400, the block of instructions identified by the instruction scanning unit 420 is emulated by the virtual machine monitor only upon determining that the block had been previously identified by the instruction scanning unit 420. In this embodiment, the hashing unit 440 compares a hashed value of a block of instructions with other hashed values in the table. If the hashed value of the block matches a hashed value in the table, the hashing unit 440 determines that the block of instructions had been previously identified by the instruction scanning unit. If the hashed value of the block does not match the hashed values in the table, the hashing unit 440 stores the hashed value in the table and only the received IO instruction, not the entire block of instructions, is emulated.

According to another embodiment of the present invention, the hashing unit 440 performs a hash function on the address of the IO instruction received by the instruction identifier 410. In this embodiment, the address is a physical address of the IO instruction in a memory in the physical machine. In response to the instruction scanning unit 420 determining that additional IO instructions are present within an extent of the received IO instruction in instructions stream, the hashing unit 440 writes the hashed address of the received IO instruction in the table. The hashing unit 440 also writes information regarding the size or length of the block of instructions as determined by the instruction scanning unit 420. In this embodiment, the hashing unit 440 compares the hashed value of an address of a received IO instruction with hashed values in the table. If the hashed value of the address matches a hashed value in the table, the hashing unit 440 directs the block of instructions recorded in the table to be emulated by the virtual machine monitor without requiring the instruction scanning unit 420 to scan an instruction stream corresponding to the received IO instruction.

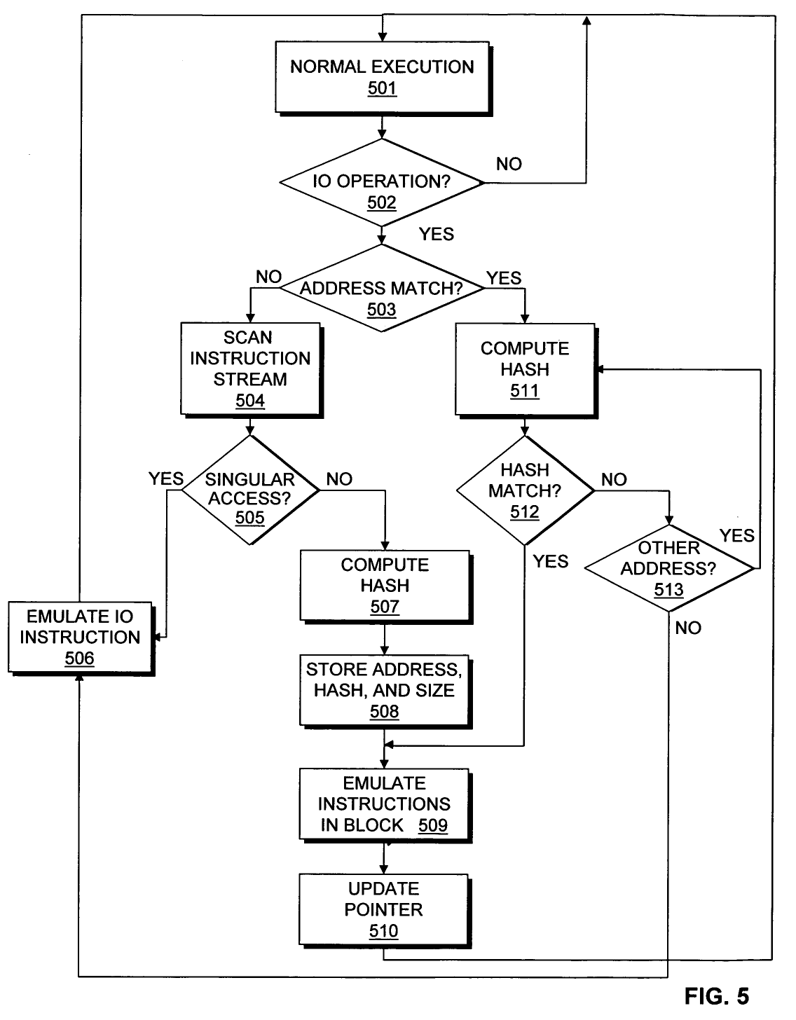

FIG. 5 is a flow chart of a method for performing input output accesses on a virtual device according to an embodiment of the present invention. At 501, normal execution of an instruction stream of an application on a virtual machine is performed.

At 502, upon encountering a virtualization event, it is determined whether the virtualization event is caused by an IO operation. According to an embodiment of the present invention, determining whether the virtualization event is caused by an IO operation is achieved by determining whether the instruction causing the virtualization event is an IN or OUT instruction or a memory mapped IO instruction. If the virtualization event is not caused by an IO operation, control returns to 501. If the virtualization event is caused by the IO operation, control proceeds to 503.

At 503, it is determined whether the address of the IO instruction for the IO operation is referenced in a table. According to an embodiment of the present invention, the table identifies blocks of instructions that may be emulated during a single virtualization event. The blocks of instructions are identified by an address of an IO instruction starting the block, a hash value of the instructions in the block and the address of the IO instruction, and a value indicating the size of the block. If the address of the IO instruction for the IO operation is stored in the table, control proceeds to 511. If the address of the IO instruction is not stored on the table, control proceeds to 504.

At 504, the instruction stream is scanned. According to an embodiment of the present invention, the instruction stream is scanned for IO instructions within an extent of instructions from the IO instruction triggering the virtualization event. The extent may be determined based upon criteria such as the type of hardware components on the system and/or the type of software being run on the system. If other IO instructions exist within the extent of instructions from the IO instruction triggering the virtualization event, these IO instructions together with any non-IO instructions between the IO instructions are grouped together and given a designation of a block of instructions.

At 505, it is determined whether the IO operation is a singular access. If the IO operation is a single IO operation within an extent of instructions from the IO instruction triggering the virtualization event, control proceeds to 506. If the IO operation is not a single IO operation with an extent of instructions from the IO instruction triggering the virtualization event, control proceeds to 507.

At 506, the IO instruction triggering the virtualization event is emulated. Control proceeds to 501.

At 507, a hash function is performed on the block of instructions determined by 504. According to one embodiment, a hash function is performed on the block of instructions and the address of the IO instruction triggering the virtualization event.

At 508, the address of the IO instruction, the hashed value computed at 507, and a value indicating the size of the block of instructions determined at 504 are stored in the table.

At 509, all of the instructions in the block of instructions are emulated. According to an embodiment of the present invention, a plurality of IO instructions is emulated during a single virtualization event.

At 510, an instruction pointer of the virtual machine executing the instruction stream is updated to indicate that the instructions in the block of instructions have been executed. Control proceeds to 501.

At 511, a hash function is performed on a block of instructions and the address of the IO instruction received. The block of instructions is determined from a value indicating a size of the block in the table.

At 512, it is determined whether the hash value computed at 511 matches a hash value corresponding to the IO address stored on the table. If the hash value matches, control proceeds to 509. If the hash value does not match, control proceeds to 513.

At 513, it is determined whether the IO address is referenced at another location in the table. If the IO address is referenced at another location in the table, control proceeds to 511. If the IO address is not referenced at another location in the table, control proceeds to 506.

It should be appreciated that once a singular access is determined at 505, that the singular access address may be stored on the table. In this embodiment, when an address match is determined at 503, it is determined whether the address is associated with a singular access. If it is determined that the address is associated with a singular access, the singular access IO instruction is emulated and control proceeds to normal execution 501. If it is determined that the address is not associated with a singular access, control proceeds to 511. This allows the number of instruction stream scans to be reduced.

It should be further appreciated that instead of computing and comparing a hash value for the block of instructions and the address of the received IO instruction (as shown in 507, 511, and 512), a hash value for the block of instructions alone may be computed and compared.

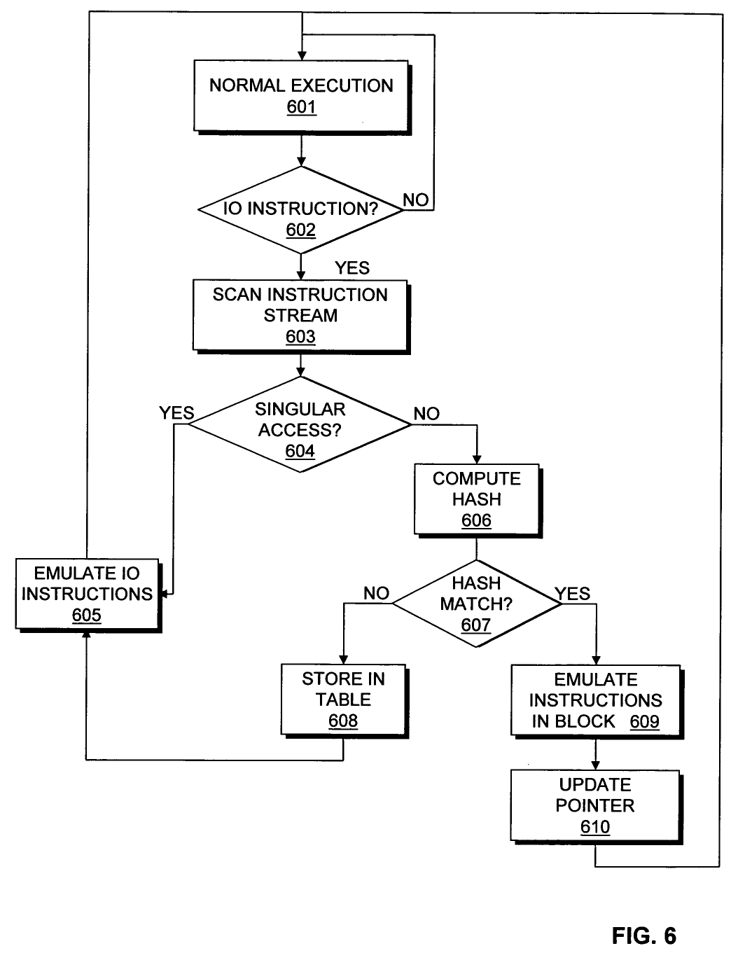

FIG. 6 is a flow chart of a method for performing input output accesses on a virtual device according to a second embodiment of the present invention. At 601, normal execution of an instruction stream in an application on a virtual machine is performed.

At 602, upon encountering a virtualization event, it is determined whether the virtualization event is caused by an IO operation. According to an embodiment of the present invention, determining whether the virtualization event is caused by an IO operation is achieved by determining whether the instruction causing the virtualization event is an IN or OUT instruction or a memory mapped IO instruction. If the virtualization event is not caused by an IO operation, control returns to 601. If the virtualization event is caused by the IO operation, control proceeds to 603.

At 603, the instruction stream is scanned. According to an embodiment of the present invention, the instruction stream is scanned for IO instructions within an extent of instructions from the IO instruction triggering the virtualization event. The extent may be determined based upon criteria such as the type of hardware components on the system and/or the type of software being run on the system. If other IO instructions exist within the extent of instructions from the IO instruction triggering the virtualization event, these IO instructions together with any non-IO instructions between the IO instructions are grouped together and given a designation of a block of instructions.

At 604, it is determined whether the IO operation is a singular access. If the IO operation is a single IO operation within an extent of instructions from the IO instruction triggering the virtualization event, control proceeds to 605. If the IO operation is not a single IO operation with an extent of instructions from the IO instruction triggering the virtualization event, control proceeds to 606.

At 605, the IO instruction triggering the virtualization event is emulated. Control proceeds to 601.

At 606, a hash function is performed on the block of instructions determined from 604 to generate a hash value.

At 607, the hash value is compared with other hash values in a table. If the hash value does not match another hash value in the table, control proceeds to 608. If the hash value matches another hash value in the table, control proceeds to 609.

At 608, the hash value is stored in the table. Control proceeds to 605.

At 609, all of the instructions in the block of instructions are emulated. According to an embodiment of the present invention, a plurality of IO instructions is emulated during a single virtualization event. Control proceeds to 610.

At 610, an instruction pointer of the virtual machine executing the instruction stream is updated to indicate that the instructions in the block of instructions have been executed. Control proceeds to 601.

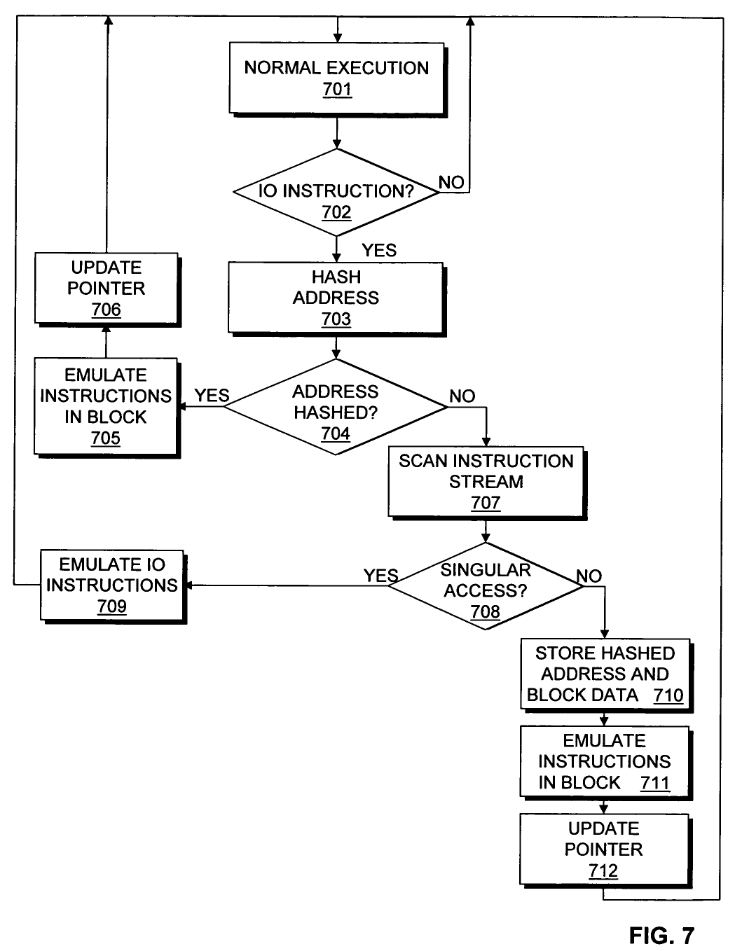

FIG. 7 is a flow chart of a method for performing input output accesses on a virtual device according to a third embodiment of the present invention. At 701, normal execution of an instruction stream of an application on a virtual machine is performed.

At 702, upon encountering a virtualization event, it is determined whether the virtualization event is caused by an IO operation. According to an embodiment of the present invention, determining whether the virtualization event is caused by an IO operation is achieved by determining whether the instruction causing the virtualization event is an IN or OUT instruction or a memory mapped IO instruction. If the virtualization event is not caused by an IO operation, control returns to 701. If the virtualization event is caused by the IO operation, control proceeds to 703.

At 703, a hash function is performed on the physical address of the IO instruction to generate a hashed address value. According to an embodiment of the present invention, the physical address is an address of the instruction in the memory in the physical machine.

At 704, a determination is made as to whether the hashed address value matches hash values in a table. If a determination is made that the hashed address value matches a hash value in the table, control proceeds to 705. If a determination is made that the hashed address value does not match a hash value in the table, control proceeds to 707.

At 705, a block of instructions associated with the matching hash value in the table is emulated.

At 706, an instruction pointer of the virtual machine executing the instruction stream is updated to indicate that the instructions in the block of instructions have been executed. Control proceeds to 701.

At 707, the instruction stream is scanned. According to an embodiment of the present invention, the instruction stream is scanned for IO instructions within an extent of instructions from the IO instruction triggering the virtualization event. The extent may be determined based upon criteria such as the type of hardware components on the system and/or the type of software being run on the system. If other IO instructions exist within the extent of instructions from the IO instruction triggering the virtualization event, these IO instructions together with any non-IO instructions between the IO instructions are grouped together and given a designation of a block of instructions.

At 708, it is determined whether the IO operation is a singular access. If the IO operation is a single IO operation within an extent of instructions from the IO instruction triggering the virtualization event, control proceeds to 709. If the IO operation is not a single IO operation with an extent of instructions from the IO instruction triggering the virtualization event, control proceeds to 710.

At 709, the IO instruction triggering the virtualization event is emulated. Control proceeds to 701.

At 710, the hashed address value and data regarding the block of instruction determined by 707 is stored in the table.

At 711, all of the instructions in the block of instructions are emulated. According to an embodiment of the present invention, a plurality of IO instructions is emulated during a single virtualization event.

At 712, an instruction pointer of the virtual machine executing the instruction stream is updated to indicate that the instructions in the block of instructions have been executed. Control proceeds to 701.

FIGS. 5-7 are flow charts illustrating methods for performing input output accesses on a virtual device according to embodiments of the present invention. Some of the techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

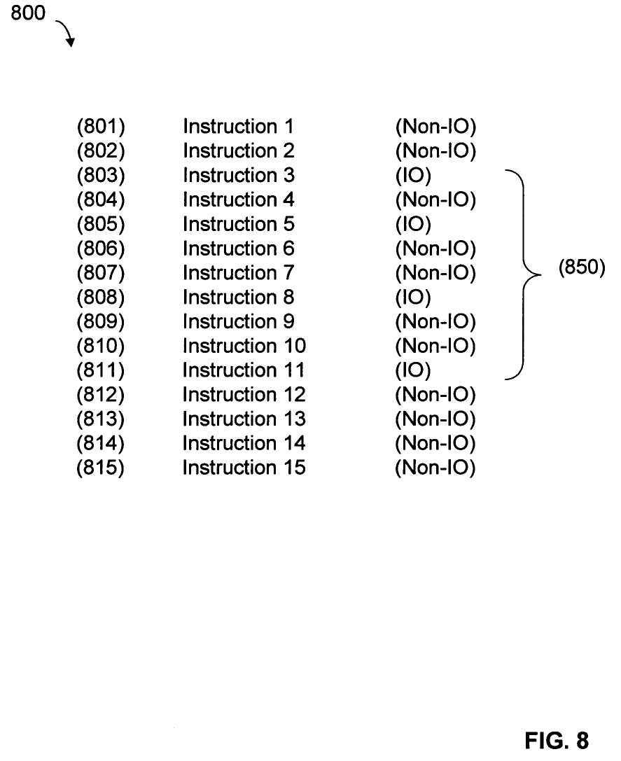

FIG. 8 is a portion of an exemplary instruction stream 800 that is processed by a virtual machine according to an embodiment of the present invention. Instructions (801)-(815) represent various instructions and for the purposes simplification are labeled instructions 1-15, respectively. Instruction 3 (803) is the first IO instruction in the instruction stream 800. When instruction 3 (803) is executed by the virtual machine, it triggers a virtualization event. According to an embodiment of the present invention, when the instruction stream 800 is scanned to determine whether additional IO instructions are within an extent of instructions of instruction 3 (803), an extent of ten instructions is used. Instructions 5 (805), instruction 8 (808), and instruction 11 (811) are identified as being other IO instructions existing within the extent. In this example, instructions 3 through 11 (803)-(811) are grouped together as block of instructions (850). This block of instructions (850) may be emulated together during the virtualization event brought by instruction (803). Although executing instructions 4 (804), instructions 6-7 (806)-(807), and instructions 9-10 (809)-(810) in a virtual machine monitor context using an emulator is less efficient than executing the instructions natively in the virtual machine, the overall number of clock cycles required for executing the instruction stream 800 may be less by reducing the number of virtualization events required for each of the instructions 5 (805), instruction 8 (808), and instruction 11 (811).

In the foregoing specification embodiments of the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

1. A method for performing virtualization, comprising:
executing a plurality of input output (IO) instructions from an instruction stream during a single virtualization event.

2. The method of claim 1, further comprising:
identifying an IO instruction; and
scanning the instruction stream to determine whether additional IO instructions are present within an extent of instructions in the instruction stream.

3. The method of claim 2, further comprising identifying the plurality of IO instructions in a block of instructions within the extent.

4. The method of claim 3, further comprising performing a hash function on the block of instructions.

5. The method of claim 2, wherein the extent is determined by a processor running in a system.

6. The method of claim 2, wherein the extent is determined by hardware in a system.

7. The method of claim 2, wherein the extent is determined by software in a system.

8. The method of claim 3, wherein executing the plurality of IO instructions comprises emulating the block of instructions.

9. The method of claim 8, further comprising updating an instruction pointer to move past the block of instructions.

10. A method for performing virtualization, comprising:
determining whether an address of an input output (IO) instruction is stored in a table;
determining whether a hash of a block of instructions in an instruction stream matches a hash value stored in the table if the address is stored in the table; and
emulating the block of instructions during a single virtualization event if a match exists.

11. The method of claim 10, further comprising identifying the block of instructions in the instruction stream with size information in the table.

12. The method of claim 10, further comprising updating an instruction pointer to move past the block of instructions.

13. The method of claim 10, further comprising scanning the instruction stream to determine whether additional IO instructions are present within an extent of instructions in the instruction stream if the address is not stored on the table.

14. The method of claim 13, further comprising:
identifying the plurality of IO instructions in a block of instructions within the extent; and
emulating the block of instructions during the single virtualization event.

15. The method of claim 13, further comprising emulating the IO instruction during the single virtualization event if additional IO instructions are not present within the extent.

16. The method of claim 14, further comprising performing a hash function on the block of instructions.

17. The method of claim 14, further comprising storing the address of the IO instruction and a hash of the block of instructions on the table.

18. An article of manufacturer comprising a machine accessible medium including sequences of instructions, the sequences of instructions including instructions which when executed causes the machine to perform:
executing a plurality of input output (IO) instructions from an instruction stream during a single virtualization event.

19. The article of manufacturer of claim 18, further comprising instructions which when executed by the machine causes the machine to perform:
identifying an IO instruction; and
scanning the instruction stream to determine whether additional IO instructions are present within an extent of instructions in the instruction stream.

20. The article of manufacturer of claim 19, further comprising instructions which when executed by the machine causes the machine to perform identifying the plurality of IO instructions in a block of instructions within the extent.

21. The article of manufacture of claim 20, wherein executing the plurality of IO instructions comprises emulating the block of instructions.

22. The article of manufacturer of claim 20, further comprising instructions which when executed by the machine causes the machine to perform updating an instruction pointer to move past the block of instructions.

23. A virtualization event dispatcher, comprising:
an instruction interpreter unit to determine whether an instruction that causes a virtualization event is an input output (IO) instruction; and
an instruction scanning unit to determine whether additional IO instructions are present within an extent from the instruction in an instruction stream and to designate the additional IO instructions in a block of instructions.

24. The virtualization event dispatcher of claim 23, further comprising an instruction pointer update unit to update an instruction pointer of a virtual machine to move past the block of instructions identified by the instruction scanning unit.

25. The virtualization event dispatcher of claim 23, further comprising a hashing unit to perform a hash function on the block of instructions identified by the instruction scanning unit.
